(19) United States
(12) Patent Application Publication
(10) Pub. No.: US 2011/0093353 A1
(43) Pub. Date: Apr. 21, 2011

(54) System and Method for Syndicating Market Offers for Intellectual Property

(76) Inventors: Arthur M. Nutter, Colorado Springs, CO (US); Matthew P. Troyer, Colorado Springs, CO (US); Carlos H. Parez, JR., Colorado Springs, CO (US)

(21) Appl. No.: 12/581,318

(22) Filed: Oct. 19, 2009

(51) Int. Cl. G06Q 30/00; G06Q 10/00; G06Q 50/00; G06F 3/048

(52) U.S. Cl. 705/26.2; 705/30; 705/34; 705/310; 705/344; 715/760

(57) ABSTRACT

A syndication server is in communication with the portal software and receives the market offer, the syndication server aggregates a number of market offers to create a syndication document. A subscriber server receives the syndication document and publishes an indication that the particular intellectual property is associated with the market offer. If a prospect clicks on the indication, the prospect is directed to a sellers website. The syndication server receives a message that the prospect has clicked on the indication and uses this information to prepare reports and pay the subscriber server's owner a click fee. Thus providing the subscriber server an incentive to publish the market offers.

### RELATED APPLICATIONS

None

### STATEMENT REGARDING FEDERALLY SPONSORED RESEARCH

Not Applicable

### THE NAMES OF THE PARTIES TO A JOINT RESEARCH AGREEMENT

Not Applicable

### REFERENCE TO A SEQUENCE LISTING, A TABLE, OR A COMPUTER PROGRAM LISTING

Not Applicable

### BACKGROUND OF THE INVENTION

Linking intellectual property (IP) sellers and IP seekers is a long standing problem in the intellectual property industry. Sellers and seekers of intellectual property assets must rely on traditional contact methods to find each other such as telephone, face-to-face contact, and postal mail. There are electronic methods such as Web sites, e-newsletters, RSS feeds, and general purpose search engines. But search engines and e-mail campaigns are unstructured and have their limits. Getting buyers and sellers together has generally been accomplished on an opportunistic basis. There have been several attempts to develop an online system that provides a centralized place to list intellectual property for sale or license in the hope of finding willing buyers who may be interested in the intellectual property asset. Yet, none has developed critical mass or been considered a place to go to research intellectual property and technology to license or buy. People interested in acquiring intellectual property have had to mine the entire patent database to find patents that may be of interest, and then approach the owner to determine if the asset is available for sale or license, and the conditions under which that asset might be available. Likewise, those having intellectual property assets that they wish to monetize have no way of conveniently reaching those people who might have an interest in acquiring rights to the asset. Relatively recent developments in patent auctions have provided a mechanism that makes an attempt at putting interested sellers in front of interested buyers, but that process does not provide for easy and confidential access to broad ranges of intellectual property assets that a company may be willing to sell or license. In the current global economy there is a need for a distributed, interconnected marketplace where interested, willing, and qualified buyers around the globe can find willing and interested sellers of intellectual property assets that meet their immediate need.

### BRIEF SUMMARY OF INVENTION

This invention solves the problem of putting interested buyers of intellectual property assets in contact with interested sellers of intellectual property assets on a global basis by providing a centralized intellectual property syndication system, which is accessed through a network of both publisher and subscriber portals. Publisher portals send market offers to the network on behalf of intellectual property sellers; subscriber portals receive market offers from the network and place them in front of potential intellectual property buyers. The invention also solves the “Tower of Babel barrier” by standardizing and organizing the way that intellectual property offers are syndicated to the network. The system also financially incentivizes subscribers to introduce potential property rights buyers to property rights sellers who publish their intellectual property market offers to the system.

The system includes portal software with a system for preparing a market offer for a particular intellectual property. A is in communication with the portal software and receives the market offer. The syndication server aggregates a number of market offers to create a syndication document. A subscriber server receives the syndication document and publishes an indication such as an icon that the particular intellectual property is associated with the market offer. When a prospect clicks on the indication, typically in the form of a hyperlinked icon or plain link, the prospect is directed to a seller's website via a URL redirection mechanism in the syndication server. The syndication server receives a message that the prospect has clicked on the indication and uses this information to bill the publisher and prepare reports and pay the subscriber server's owner a click fee, thus providing the owner of the subscriber server an incentive to publish the market offers.

### BRIEF DESCRIPTION OF THE SEVERAL VIEWS OF THE DRAWINGS

FIG. 1 is a flow diagram of a system overview of the invention in accordance with one embodiment of the invention;

FIG. 2 is a flow diagram of the system from a product flow point of view in accordance with one embodiment of the invention;

FIG. 3 is a flow diagram of the system from an intellectual property seller's point of view in accordance with one embodiment of the invention;

FIG. 4 is a flow diagram of the system from an intellectual property seeker's point of view in accordance with one embodiment of the invention; and

FIG. 5 is flow diagram of an alternative system in accordance with one embodiment of the invention.

### DETAILED DESCRIPTION OF THE INVENTION

This invention solves the problem of putting interested buyers of intellectual property assets in contact with interested sellers of intellectual property assets on a global basis by providing a centralized intellectual property syndication system, which is accessed through a network of both publisher and subscriber portals. The invention also solves the “Tower of Babel barrier” by standardizing and organizing the way that intellectual property offers are syndicated to the network. The system also financially incentivizes subscribers to introduce potential property rights buyers to property rights sellers who publish their intellectual property market offers to the system.

### Glossary

A glossary of the main terms used in this patent is provided below:
Billing information—is the address, contact information, and may include credit card information necessary for billing the IP asset owner.
Category—a definition of a market area where the IP asset is most likely to be useful.
Clicks—selects a hyperlink in a browser.
Commission—the amount or percentage of money a subscriber web site owner or third-party agent receives when an IP seeker clicks on an indication that an IP asset has an associated market offer.
Intellectual property asset—is a patent, trademark, copyright, trade secret or other IP asset such as know how.
Intellectual property seller's site—is a website where the IP seller hosts market offers for IP assets that can be publicly viewed.
IP hosted web site—a web site that is used to host market offers for an IP seller.
Market offer—the terms under which the IP owner is willing to sell or license an IP asset which may include a detailed description of the IP asset.
Reports—a statement of the activity associated with a market offer, including views, general information about viewers, and clicks, billing details, and commission details.
Portal—a means of preparing a syndication document and transmitting it to a syndication server.
Publication Server—a server that collects market offers and transmits information about the market offers when queried.
Syndication document (or syndicated document)—is an electronic document that generally contains information about multiple market offers, but could contain information about a single market offer.
Subscriber server—is a server that receives a syndication document from the syndication server.
Syndicating—transmitting a syndication document to multiple subscriber servers, but could be to a single subscriber server.
Syndication server—a server that collects market offers and creates a syndication document.
XML—eXtensible Markup language.

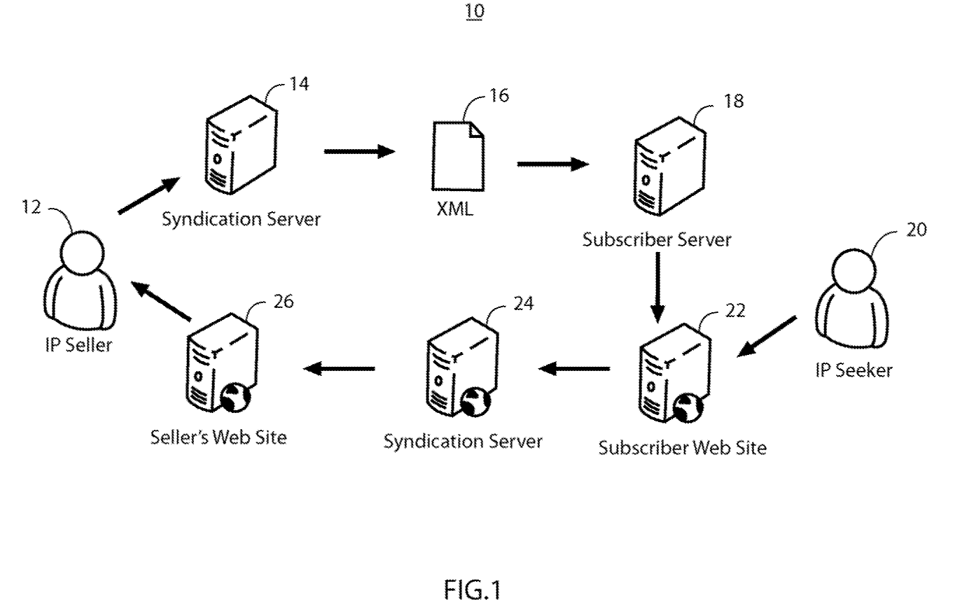

FIG. 1 is a flow diagram of a system 10 overview of the invention in accordance with one embodiment of the invention. An intellectual property seller 12 creates a market offer for a particular intellectual property asset. The market offer will include the type of intellectual property asset, whether it is for sale or license and the terms associated with the sale or lease. The market offer may be created using portal software. The market offer is transmitted to a syndication server 14. The syndication server 14 aggregates a number of market offers and creates a syndication document 16, which may be an XML (eXtensible Markup Language) document in one case. The syndication document is transmitted to a number of subscriber servers 18. The subscriber server 18 publishes an indication that the particular intellectual property asset has an associated market offer. An intellectual property seeker 20 views the subscriber web site 22, where they may see the indication that the particular intellectual property asset has an associated market offer. This may occur because the IP seeker 20 did a search for intellectual property assets and the particular intellectual property asset fit the search criteria. When the IP seeker 20 clicks on the indication, the IP seeker 20 is redirected to the syndication server 24 where the click is logged and then redirected to the IP seller's web site 26. The IP seeker 20 is able to view the market offer on the seller's web site 26.

An example of how the system might work has a University with various patents that it wants to sell or license. It creates a market offer and transmits it to the syndication server 14. The syndication server 14 transmits information about the market offers in the syndication document 16 to a number of subscriber servers 18, such as Google® Patents, PatentScope®, and other patent searching web sites. A technology company 20 is attempting to solve a problem and does a patent search on the subscriber web site 22 for technology that will resolve their issue. The technology company notices an indication that a patent related to their problem includes a market offer. They click on the indication, which is logged, and the technology company is directed to the University's web site 26 where they can view the market offer. The logging of the click results in a click fee being paid by the University and a commission being paid to the subscriber server's owner 18. In addition, various reports are generated related to the click and provided to the University 12 as well as the subscriber server 22 owners.

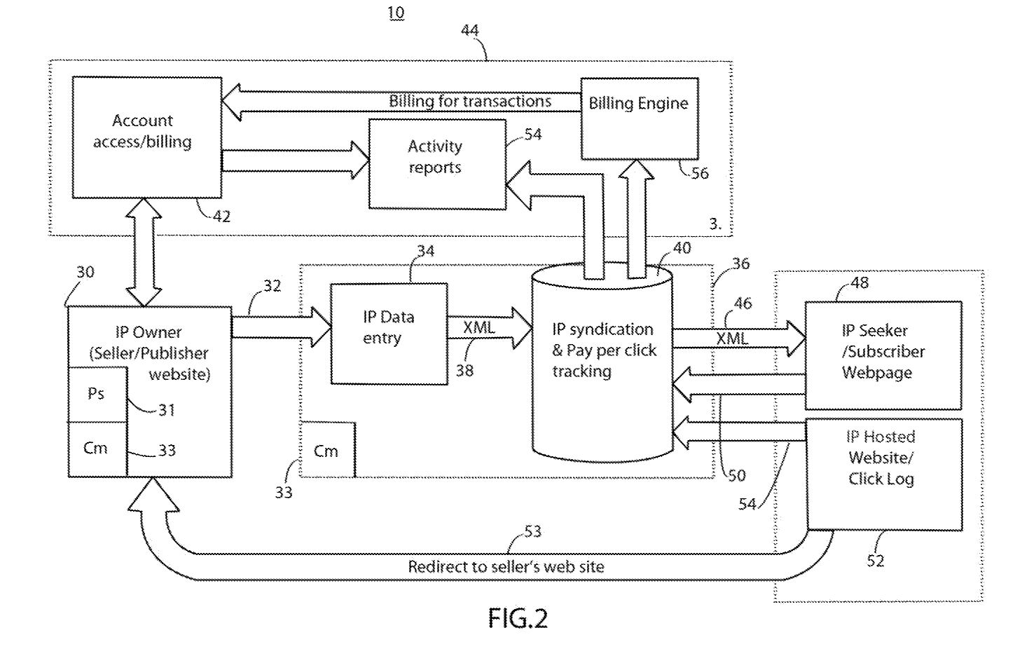

FIG. 2 is a flow diagram of the system 10 from a product flow point of view in accordance with one embodiment of the invention. An IP owner 30 creates a market offer. The market offer may be created using a portal software 31 that makes it easy to manage the IP owner's web site and market offers. The intellectual property asset associated with the market offer is placed in a market category by the category manager 33. Categories are centrally managed and are replicated to the IP owner's portal. The category manager solves the problem of consistently categorizing IP into fields of use for easy retrieval and organization. For example, a high-temperature sensor patent classified under semiconductors might be categorized for the automotive, manufacturing and aerospace industries. The IP owner can select a different market category from a list of categories in the category manager 33. However, the category manager 33 associated with the syndication system 36 makes sure that the definitions for each category are consistent across all IP sellers. The market offer is transmitted 32 to the IP data entry system 34 of the syndication system 36. The IP owner 30 also transmits various billing information to the account access/billing document 42 of the accounting system 44.

In one embodiment, when the IP owner enters a patent or other IP asset into the portal software 31, the portal software 31 queries a public web site such as a patent web site or internal database to find a plurality of information associated with the asset and automatically fills in certain information in the market offer.

The IP data entry system 34 converts the market offer into an XML (eXtensible Markup Language) document 38 that is transmitted to the IP syndication database 40. The syndication database 40 aggregates a number of market offers from a number of IP owners and transmits a syndication document 46 to a subscriber web server 48. When an IP seeker 48 clicks on an indication that an IP asset has a market offer, information about the click 50 is transmitted to the pay per click tracking database 40. Alternatively, the IP seeker may be directed to an IP hosted website 52 to view the market offer. If the IP seeker wants to open negotiations, he may click on another link and be directed 53 to the IP owners website 30. The click is logged 54. Information about the clicks is sent to the billing engine 56 and to the activity reports 58. Activity reports and invoices are sent to the IP owner or owner of the originating portal.

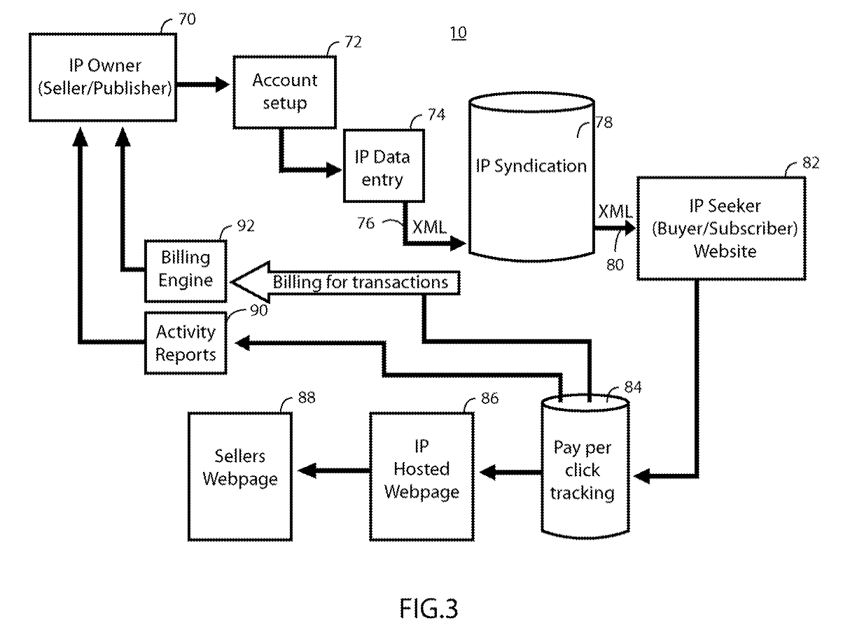

FIG. 3 is a flow diagram of the system 10 from an intellectual property seller's point of view in accordance with one embodiment of the invention. The IP owner 70 sets up an account 72 with the syndicator. Next the IP owner creates a market offer by entering IP data 74. The market offer is converted into an XML document and transmitted 76 to the IP syndication database 78. Next a syndication document 80 is transmitted to a subscriber web site 82, where a IP seeker finds the market offer. When the IP seeker clicks on an indication that the IP asset has an associated market offer, the click is tracked by a pay per click database 84 and then the IP seeker is directed either to a hosted webpage 86 or the seller's webpage 88. The information about the click is transmitted an activity report creation system 90 and a billing engine 92. The IP owner is then billed and receives activity reports.

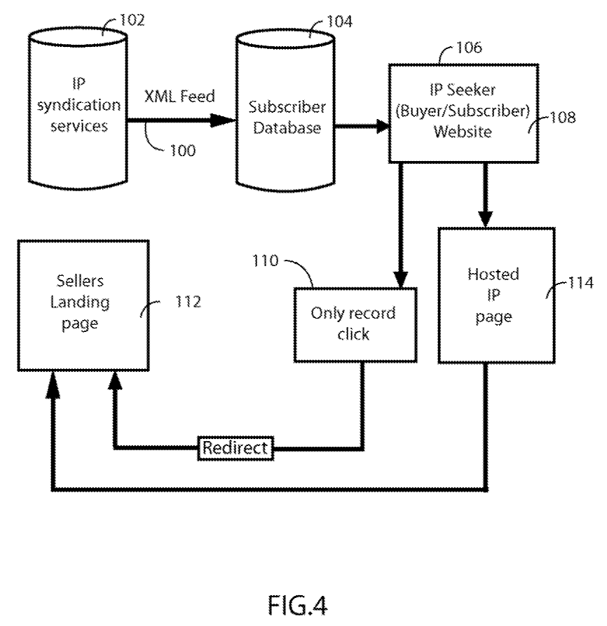

FIG. 4 is a flow diagram of the system 10 from an intellectual property seeker's point of view in accordance with one embodiment of the invention. An IP syndication document 100 is transmitted by an IP syndicator 102 to a subscriber database 104. In one embodiment the syndication document 100 is an XML document in order to facilitate easy access of the information. When an IP seeker (prospect) views the subscriber website 106 and clicks on the indication 108 that an IP asset has an associated market offer, the click is recorded 110. The prospect is then redirected to the seller's landing page 112 where they can view the market offer and find contact information related to the offer. Alternatively, the prospect may be directed to a hosted IP page 114. The purpose of the hosted IP page 114 is for IP sellers who do not have their own webpage or as a way of screening for serious IP seekers only.

In another embodiment, rather than processing a syndication document, the seeker's web site is instrumented in such a way that the web page is updated real-time with a link to the market offer. This can be accomplished using JavaScript and Dynamic Hypertext Markup Language (DHTML) or a browser plug-in. The JavaScript function will match on patent numbers or other unique IP identifiers and send a query to the publication server. If the publication server finds that the IP is being offered, the results are sent back to the seeker's web site and a new link and icon are rendered on the page. This mechanism has the advantage that the processing is done within the context of a web browser and an XML publication document is not required to be downloaded and post-processed by the seeker's web server.

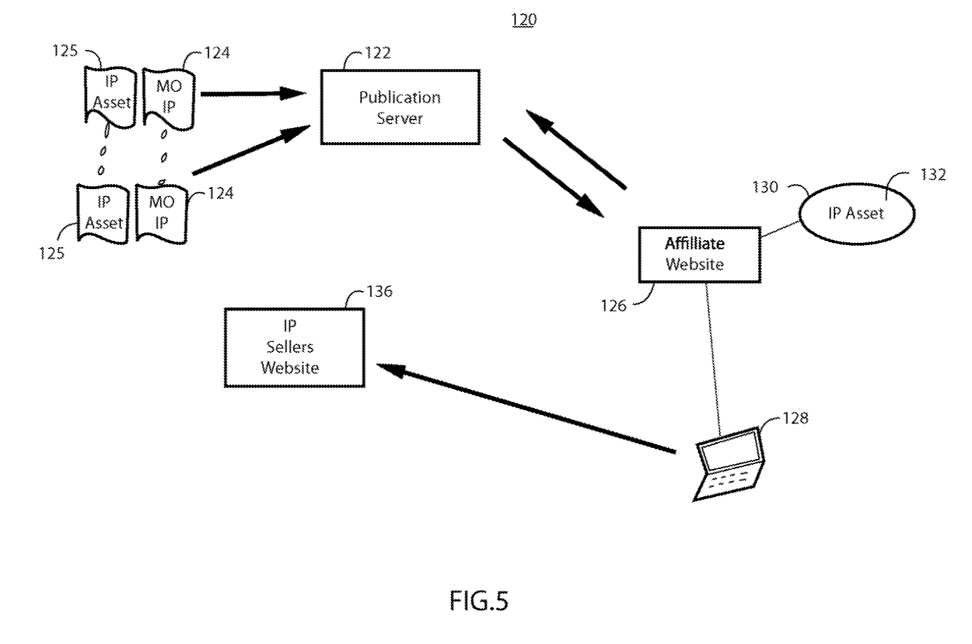

FIG. 5 is flow diagram of an alternative system 120 in accordance with one embodiment of the invention. A publication server 122 receives a plurality of market offers 124. The market offers 124 contain the basic terms that an IP owner is requesting for an offered intellectual property asset 125 . An affiliate web site 126 is visited by prospect 128. When the affiliate web site 126 is about to present a displayed intellectual property asset 130, it queries the publication server 122 to determine if the displayed intellectual property asset 130 is the offered intellectual property asset. When the displayed intellectual property asset 130 is the offered intellectual property asset 125, transmitting an indication 132 that the displayed intellectual property asset has an associated market offer 124 to the affiliate web site 126. The indication 132 is displayed next the displayed intellectual property asset 130 on the affiliate web site 126. When the prospect 128 clicks on the indication 132, redirecting the prospect 128 to an IP seller's web site 136, where the prospect 128 can view the market offer 124. In one embodiment, the publication server 122 receives a message that the prospect clicks on the indication 132. The publication server 122 uses this information to charge the IP seller a click fee and to pay the affiliate web site a commission 126. The click information can also be used to create a report of activity for the IP seller.

Thus there has been described a system that allows IP sellers to widely distribute indications that they have an IP asset for sale or license. The subscriber web sites have an incentive to get IP seekers to view the market offers. The subscriber web sites are web sites that the IP seekers already to frequents relieving them of the need to visit a special web site to find out about market offers for IP. The IP seller retains control of how the market offer can be viewed. As a result, a distributed, interconnected marketplace is created where interested, willing, and qualified buyers around the globe can find willing and interested sellers of intellectual property assets that meet their immediate need.

The methods described herein can be implemented as computer-readable instructions stored on a computer-readable storage medium that when executed by a computer will perform the methods described herein.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A system for syndicating market offers for intellectual property, comprising:
a market offer for an intellectual property;
a syndication server receiving the market offer, the syndication server aggregating a plurality of market offers and creating a syndication document; and
a subscriber server receiving the syndication document and publishing an indication that the particular intellectual property is associated with the market offer, when a prospect clicks on the indication directing the prospect to a sellers website.

2. The system of claim 1, wherein the syndication server receives a message that the prospect clicks on the indication.

3. The system of claim 2, further including an accounting system in communication with the syndication server.

4. The system of claim 3, wherein the accounting system bills a seller associated with the market offer.

5. The system of claim 3, wherein the accounting system pays a commission.

6. The system of claim 1, wherein the syndication document is an XML document.

7. A method for syndicating market offers for intellectual property, comprising the steps of:
receiving a market offer for an intellectual property asset at a syndication server from a seller;
embedding the market offer in a syndication document;
syndicating the syndication document to a plurality of subscribers;
publishing an indication of the market offer by one of the plurality of subscribers on a subscribers website; and
tracking a click by a user on the indication.

8. The method of claim 7, further including the steps of:
directing the user to a sellers website.

9. The method of claim 7, wherein the market offer is created using a portal software.

10. The method of claim 9, wherein when the intellectual property asset is a patent, retrieving a plurality of information related to the patent from a patent website.

11. The method of claim 9, wherein the step of receiving a market offer includes the step of a categorizing a patent.

12. The method of claim 7, further including the step of directing the user to an IP hosted webpage.

13. The method of claim 7, further including the step of providing the seller and subscriber a report.

14. A method for publishing market offers for intellectual property comprising the steps of:
storing a market offer at a publication server;
querying the publication server to determine if an intellectual property asset to be displayed has a published market offer;
when the intellectual property asset has the market offer, transmitting an indication that the intellectual property asset has the market offer; and
displaying the indication of the market offer on an affiliate web site.

15. The method of claim 14, further including the steps of when a prospect clicks on the indication, collecting a plurality of information associated with the click.

16. The method of claim 15, further including the step of redirecting the prospect to a sellers web site.

17. The method of claim 16, further including the step of charging a seller a click fee.

18. The method of claim 16, further including the step of paying a commission.

19. The method of claim 14, wherein a seller uses portal software to prepare the market offer.

20. The method of claim 19, wherein the portal software prepares a market offer message and transmits the market offer message to the publication web site.

21. A method of operating a portal system for managing intellectual property assets, comprising the steps of:
defining a market offer for an intellectual property asset;
storing a market offer to a server; and
transmitting a market offer to a syndication server.

22. The method of claim 21, further including the step of:
receiving a syndication document from a syndication document containing a plurality of market offers;
storing the plurality of market offers on the server.
